(19) United States
(12) Patent Application Publication
(10) Pub. No.: US 2025/0140242 A1
(43) Pub. Date: May 1, 2025

(54) GENERATING AUDIO REPRESENTATIONS USING MACHINE LEARNING MODEL

(71) Applicant: Lemon Inc., Grand Cayman (KY)

(72) Inventors: Zongyu Yin, London (GB); Qingqing Huang, Culver City, CA (US); Janne Jayne Harm Renee Spijkervet, London (GB)

(21) Appl. No.: 18/385,749

(22) Filed: Oct. 31, 2023

(51) Int. Cl. G10L 15/18; G06N 20/00

(52) U.S. Cl. CPC G10L 15/18; G06N 20/00

(57) ABSTRACT

The present disclosure describes techniques for generating audio representations using a machine learning model. A machine learning model is pre-trained using unlabeled audio data. The pre-training enables the machine learning model to recognize audio patterns and generate initial audio representations. The machine learning model is refined by a task-specific fine-tuning process using labeled data. The task-specific fine-tuning process incorporates multi-task learning heads to optimize the machine learning model. The task-specific fine-tuning process enables the machine learning model to be specialized in specific audio tasks and generate continuous audio representations. The continuous audio representations retain acoustic nuances and subtleties of audio signals. The machine learning model is configured and enabled to generate quantized audio representations by incorporating vector quantization to the task-specific fine-tuning process.

### BACKGROUND

Machine learning models are increasingly being used across a variety of industries to perform a variety of different tasks. Such tasks may include audio-related tasks. Improved techniques for utilizing machine learning models for audio-related tasks are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for training a machine learning model to generate audio representations in accordance with the present disclosure.

FIG. 2 shows an example system for training a machine learning model to generate audio representations in accordance with the present disclosure.

FIG. 3 shows an example system for training a machine learning model to generate audio representations in accordance with the present disclosure.

FIG. 4A shows an example system for generating continuous audio representations using a machine learning model in accordance with the present disclosure.

FIG. 4B shows an example system for generating quantized audio representations using a machine learning model in accordance with the present disclosure.

FIG. 5 shows an example process for generating audio representations using a machine learning model in accordance with the present disclosure.

FIG. 6 shows an example process for generating audio representations using a machine learning model in accordance with the present disclosure.

FIG. 7 shows an example process for generating audio representations using a machine learning model in accordance with the present disclosure.

FIG. 8 shows an example process for generating audio representations using a machine learning model in accordance with the present disclosure.

FIG. 9 shows an example process for generating audio representations using a machine learning model in accordance with the present disclosure.

FIG. 10 shows an example process for generating audio representations using a machine learning model in accordance with the present disclosure.

FIG. 11 shows an example process for generating audio representations using a machine learning model in accordance with the present disclosure.

FIG. 12 shows an example computing device which may be used to perform any of the techniques disclosed herein.

### DETAILED DESCRIPTION OF ILLUSTRATIVE EMBODIMENTS

Machine learning models may be used to generate audio. Such machine learning models primarily include self-supervised semantic models (hereinafter referred to as “semantic models”). These semantic models may learn abstract representations of audio, and then two or more generation models may be trained to complete the process of generating audio from conditional signals through intermediate representations. Therefore, the quality of intermediate representations often determines the learning difficulty of generation models in downstream tasks and the accuracy of audio reconstruction.

These semantic models may be widely used in text-to-speech, lyrics-to-song, prompt-to-audio, and various Music Information Retrieval (MIR) tasks. However, most existing semantic models focus primarily on handling speech-related tasks. When applied to more complex audio-related tasks, such as music-related tasks, existing semantic models do not perform as well. For example, when generating songs with vocals, pronunciation may be unclear, melody reconstruction may have errors, musicality may decline, and even some details may be lost. As such, improved techniques for generating audio representations are needed.

Described herein are improved techniques for generating audio representations. The audio representation generation techniques described herein solve the limited effectiveness of existing semantic models when applied to audio-related tasks beyond speech, such as in the domain of lyrics-to-song generation. Described herein is a novel framework for universal audio representation learning. Within this framework, a semantic model that addresses the shortcomings of previous models is trained. This new model performs well in audio-related tasks beyond speech, e.g., in the task of converting lyrics into songs. The key innovation lies in how this model learns and represents audio information, allowing it to overcome the aforementioned shortcomings of existing models. The new and improved semantic model described herein is able to generate audio representations that may be used to generate audio, such as songs, with clearer pronunciation, higher musicality, reduced errors, preserved details, and versatility.

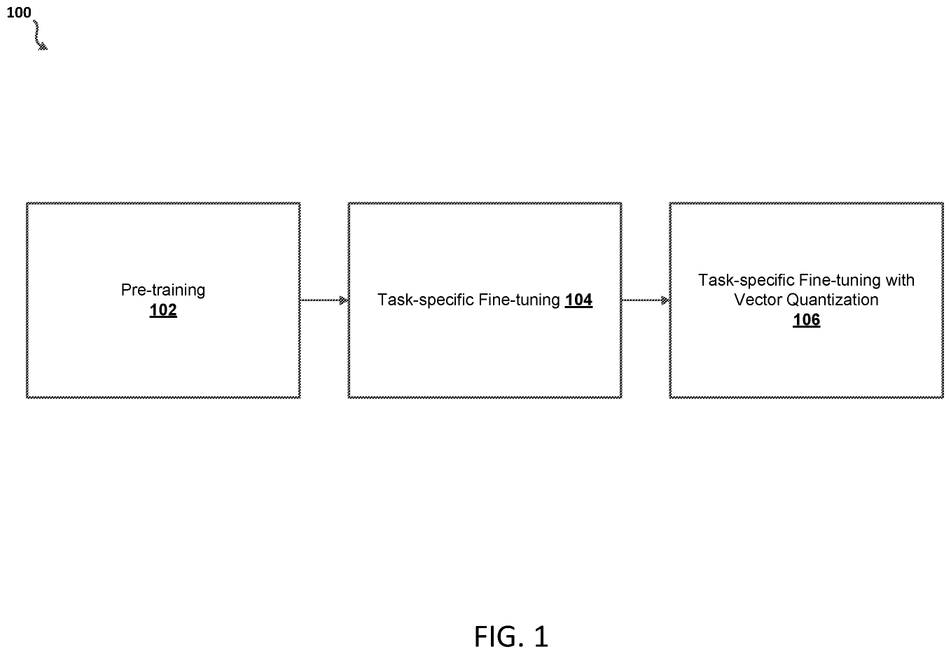

FIG. 1 illustrates an example framework 100 in accordance with the present disclosure. The framework 100 may be used for training a machine learning model to generate audio representations. The framework 100 may include three stages: pre-training 102, task-specific fine tuning 104, and task-specific fine-tuning with vector quantization 106. Each of these three stages of training are meticulously designed to facilitate the learning and utilization of the machine learning model for universal audio representations.

During the pre-training 102 stage, the machine learning model may be pre-trained using unlabeled audio data. The pre-training 102 may enable the machine learning model to recognize audio patterns and generate initial audio representations. The pre-training 102 may serve as the foundation for initializing the machine learning model's understanding of audio data. The pre-training 102 may equip the machine learning model with a strong initial grasp of audio representations, allowing it to capture essential audio features, patterns, and structures. The pre-training 102 may comprise training the machine learning model on a vast corpus of unlabeled audio data, enabling it to develop a broad and general understanding of audio information. The pre-training 102 focuses on unsupervised learning, where the machine learning model learns to recognize meaningful audio patterns without task-specific labels.

In embodiments, the pre-training 102 may apply random projections to project input audio signals to a randomly initialized codebook, and then map them to discrete labels by finding the nearest vector in the codebook. The pre-training 102 may enable an encoder of the machine learning model to take masked input audio signals and predict the labels corresponding to the masked part provided by a random projection quantizer. For example, the pre-training 102 may mask the audio signals and train the machine learning model to predict labels corresponding to the masked parts. The masked audio signals may be fed to an encoder of the machine learning model. The encoder may learn to predict the masked region based on the unmasked audio signals. The learning targets may be labels provided by the random projection quantizer. The random projection quantizer may project the audio signals to a randomly initialized matrix. The random projection quantizer may find a nearest vector in a randomly initialized codebook. The index of that vector may be the target label. Neither the projection matrix nor the codebook is updated throughout the learning process. The quantizer does not require representation learning. Once the pre-training 102 is complete, the machine learning model possesses a versatile audio representation that can be fine-tuned for specific audio tasks.

During the task-specific fine tuning 104 stage, the machine learning model may be trained using labeled data specific to various target tasks, allowing the machine learning model to adapt its representations and capabilities to excel in that task. The task-specific fine tuning 104 refines the machine learning model's understanding and performance, making it task-specific while retaining its universal audio knowledge. The task-specific fine tuning 104 enhances the machine learning model's performance by incorporating multi-task learning heads, each tailored to address specific objectives. These three heads are designed to optimize the machine learning model's capabilities for distinct audio-related tasks: audio feature reconstruction, harmonic feature reconstruction, and Automatic Speech Recognition (ASR). The task-specific fine-tuning 104 process enables the machine learning model to be specialized in specific audio tasks and generate continuous audio representations. The continuous audio representations retain acoustic nuances and subtleties of audio signals. Once the task-specific fine tuning 104 is complete, a vector quantizer may be used to further enhance the machine learning model.

During the task-specific fine-tuning with vector quantization 106 stage, a vector quantizer may be used. The vector quantizer may be inserted at a midpoint of an encoder. The task-specific fine-tuning with vector quantization 106 may enhance the machine learning model's capabilities and training stability. Incorporating a vector quantizer may enable a large language model to model semantic tokens effectively. This is particularly valuable for prediction tasks, where the vector quantizer may be used to represent audio content in a compressed, tokenized form that can be processed by the large language model.

These three stages together form a comprehensive framework that empowers the machine learning model to handle a wide range of audio-related tasks effectively. It starts with a broad understanding of audio and progressively specializes in specific tasks while maintaining versatility and adaptability. This systematic approach ensures that the machine learning model can provide high-quality results across various applications in the field of audio generation and representation learning.

The machine learning model trained using the three-stage framework 100 may produce audio representations that may be used by downstream models. By using the audio representations produced by the machine learning model trained through the three-stage framework 100, the downstream models may be able to generate audio with enhanced clarity of pronunciation, resulting in more intelligible and coherent vocal performance. By using the audio representations produced by the machine learning model trained using the three-stage framework 100, the downstream models may be able to generate audio with high musicality. Despite the improvements in pronunciation, the downstream model may still be able to generate audio with a high level of musicality, ensuring that the generated content remains enjoyable and melodically pleasing. By using the audio representations produced by the machine learning model trained using the three-stage framework 100, the downstream models may be able to generate audio with reduced errors. For example, melody reconstruction errors may be minimized, leading to more accurate and faithful renditions of the intended musical compositions. By using the audio representations produced by the machine learning model trained using the three-stage framework 100, the downstream models may be able to generate audio with preserved details. For example, the downstream models may be able to generate audio while retaining finer details, ensuring that the acoustic nuances and subtleties are captured in the learned representation. By using the audio representations produced by the machine learning model trained using the three-stage framework 100, the downstream models may be able to generate audio in a more versatile manner. For example, the downstream models may be able to generate audio in a variety of domains, including lyrics-to-song conversion and speech-related tasks. This versatility arises from the inherent strength of the trained machine learning model in capturing and representing audio information effectively.

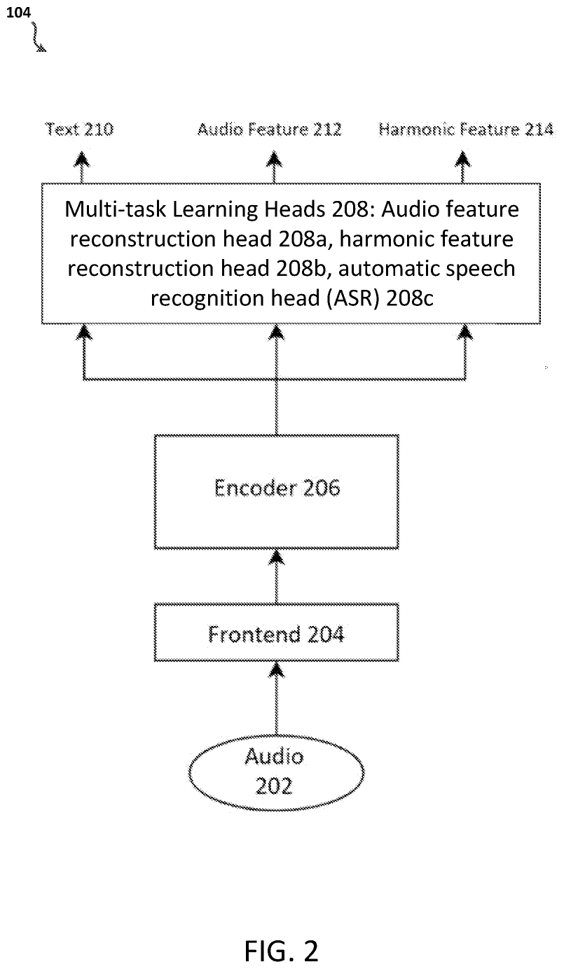

FIG. 2 shows an example task-specific fine-tuning 104 process. Audio 202 may be input into a frontend 204 of the machine learning model. The machine learning model may already have been pre-trained. For example, the machine learning model may have been pre-trained to recognize audio features, audio patterns, and audio structures without being given task-specific labels. The audio 202 may comprise audio signals. The audio 202 may be converted into a representation by being input into the frontend 204. The representation of the audio may comprise, for example, a spectrogram representing the audio. The spectrogram may be input into an encoder 206 of the machine learning model.

The encoder 206 may receive, as input, the representation of the audio. The encoder 206 may be configured to generate audio embeddings associated with the audio. For example, the encoder may comprise a stack of layers configured to generate the audio embeddings based on the spectrogram representing the audio.

The audio embeddings may be input into each of the multi-task learning heads 208. As described above, each of the multi-task learning heads 208a-c may be tailored to address a specific objective or task. The multi-task learning heads 208 may comprise an audio feature reconstruction head 208a, a harmonic feature reconstruction head 208b, and an automatic speech recognition (ASR) head 208c. By incorporating these three multi-task learning heads 208a-c during the fine-tuning stage, the machine learning model becomes highly adaptable to a wide range of audio-related tasks. This adaptability ensures that the machine learning model can perform effectively in diverse applications while maintaining its core capabilities in universal audio representation learning.

The audio feature reconstruction head 208a may be configured to enable the machine learning model to recognize frequency content of the audio signals. The audio feature reconstruction head 208a may be configured to reconstruct one or more audio features 212 associated with the audio. The audio feature(s) 212 may provide a rich source of information about the distribution of sound frequencies over time. By specializing in audio feature reconstruction, the machine learning model becomes adept at understanding the frequency content of audio, which is essential for both speech and music. The features learned through audio feature reconstruction are transferable between speech and music. This means that the machine learning model can recognize and manipulate common frequency patterns that exist in both types of audio, i.e., the speech type of audio and the music type of audio.

The harmonic feature reconstruction head 208b may be configured to enable the machine learning model to recognize and preserve harmonic information in the audio signals. The harmonic feature reconstruction head 208b may be configured to reconstruct one or more harmonic features 214 of the audio. The harmonic information or features may comprise musical information related to pitch and tonality. By specializing in harmonic feature reconstruction, the machine learning model becomes proficient in recognizing and preserving harmonic information in audio signals. By focusing on harmonic aspects, the machine learning model enhances the musicality of the generated content, making it more enjoyable and melodically pleasing.

The ASR head 208c may be configured to enable the machine learning model to transcribe spoken words into text 210. For example, the ASR head 208c may be configured to transcribe spoken words in the audio to written text. The ASR head 208c may enable the machine learning model to convert spoken words into written text with a high precision. The ASR head 208c may be dedicated to improving the machine learning model's performance in understanding and transcribing spoken language. The ASR head 208c may fine-tune the machine learning model's parameters to excel in ASR tasks, ensuring that the machine learning model can convert spoken words into written text with high precision. The ASR head 208c inherently forces the machine learning model to capture and represent features related to pronunciation.

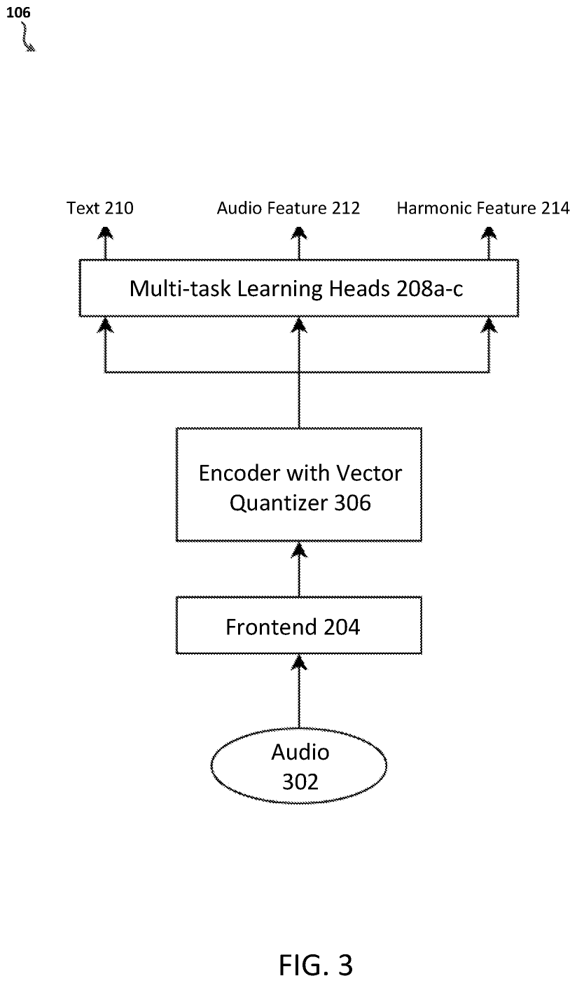

FIG. 3 shows an example task-specific fine-tuning with vector quantization 106 process. The task-specific fine-tuning with vector quantization 106 process may incorporate vector quantization to a task-specific fine-tuning process, e.g., the task-specific fine-tuning 104. As described above with regard to FIG. 2, audio 202 may be input into the frontend 204 of the machine learning model (e.g., the pre-trained machine learning model). The audio 202 may comprise audio signals. The audio 202 may be converted into a representation, e.g., a spectrogram representing the audio signals.

The encoder with vector quantizer 306 may receive, as input, the representation of the audio. The encoder with vector quantizer 306 may comprise a stack of layers. A vector quantizer may be inserted in the stack of layers. The vector quantizer enables the machine learning model to generate quantized (e.g., tokenized, compressed) audio representations associated with the audio. The quantized audio representations may be generated based on continuous audio representations (e.g., continuous audio representations generated during the second stage of task-specific fine-tuning 104). Vector quantization may involve quantizing continuous data into a finite set of representative vectors, known as codebook vectors or centroids. The goal of vector quantization is to minimize the distortion between the input data and the codebook vectors, thereby achieving a compact representation of the data while preserving as much information as possible.

One issue with vector quantization may be the potential for codebook collapse during training. Codebook collapse occurs when the machine learning model predominantly uses only a small subset of codes from the codebook, leading to a limited range of possible quantized representations. The separation of the task-specific fine-tuning 104 process and the task-specific fine-tuning with vector quantization 106 process contributes to the stabilization of vector quantizer training and can benefit the usage of the codebook.

Depending on the requirements of different downstream tasks, users have the flexibility to choose between the machine learning model that has been trained using the task-specific fine-tuning 104 process (which provides continuous audio representations) and the machine learning model that has been trained using the task-specific fine-tuning with vector quantization 106 process (which provides quantized audio representations). For tasks that benefit from continuous audio representations, such as MIR tasks that require richer audio features, the machine learning model that has been trained using the task-specific fine-tuning 104 process can be employed. Conversely, for tasks where quantized audio representations are suitable or preferred, such as tasks involving token-based prediction, the machine learning model that has been trained using the task-specific fine-tuning with vector quantization 106 process can be used.

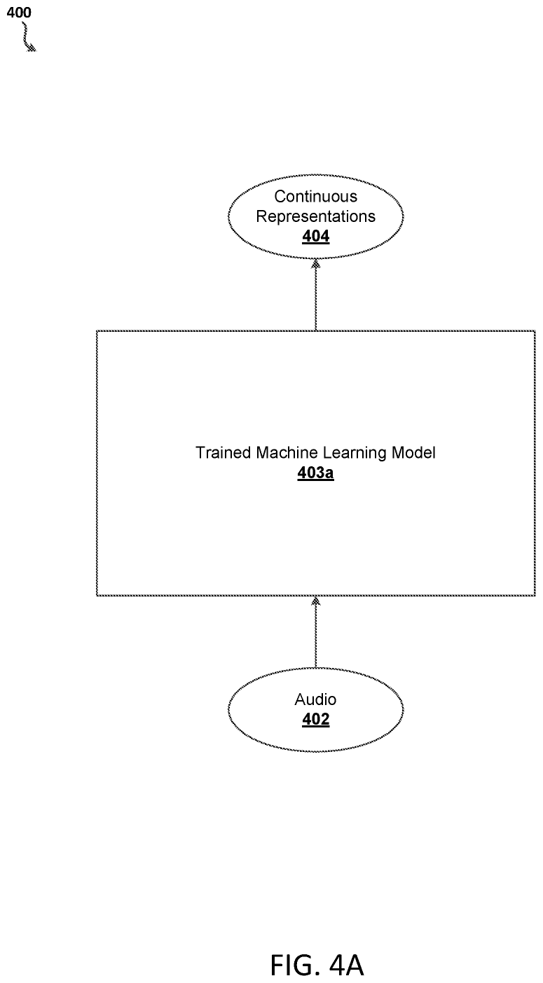

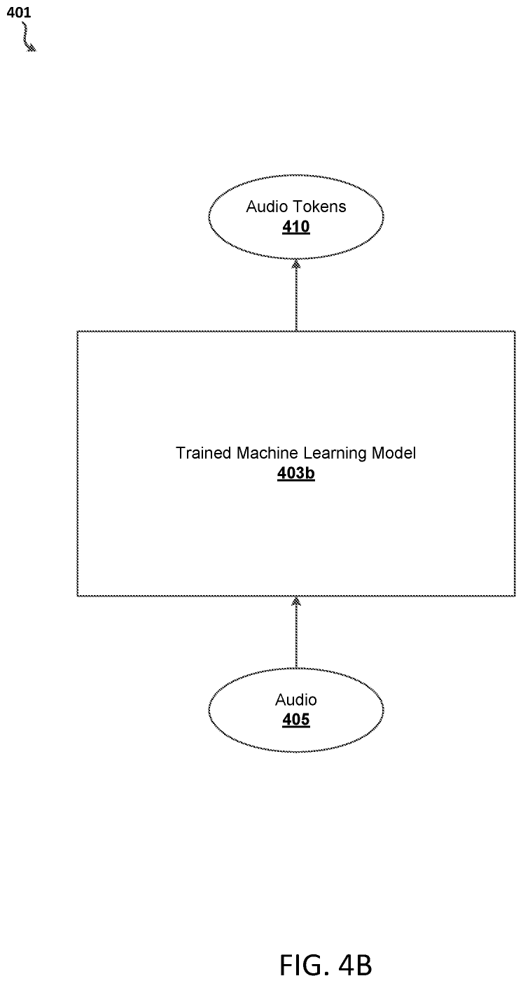

In embodiments, if a user wants to utilize a downstream machine learning model that performs a task using continuous audio representations, the user may first utilize the machine learning model that has been trained by the task-specific fine-tuning 104 process (without vector quantization) to generate continuous audio representations. FIG. 4A illustrates an example system 400 for generating continuous representations using the machine learning model 403a that has been trained using the task-specific fine-tuning process 104 without vector quantization. The user may input audio 402 into the frontend of the trained model 403a. The trained model 403a may be configured to generate the continuous audio representations 404 associated with the audio 402. The continuous audio representations 404 may retain the acoustic nuances and subtleties of the original audio signals. Then, the user may input the continuous audio representations 404 into the downstream machine learning model. The downstream machine learning model may utilize the continuous audio representations 404 to perform a certain task, such as one or more of a text-to-speech task, a lyrics-to-song task, a prompt-to-audio task, and various Music Information Retrieval (MIR) tasks.

In other embodiments, if a user wants to utilize a downstream machine learning model that performs a task using quantized audio representations, the user may first utilize the machine learning model that has been trained using the task-specific fine-tuning 106 process with vector quantization 106 to generate quantized audio representations. FIG. 4B illustrates an example system 401 for generating quantized representations using the machine learning model 403b that has been trained using the task-specific fine-tuning process with vector quantization 106. The user may input audio 405 into the frontend of the trained model 403b. The trained model 403b may be configured to generate the quantized audio representations (e.g., audio tokens 410) associated with the audio 405. The trained model 403b may be configured to generate the quantized audio representations (e.g., audio tokens 410) associated with the audio 405 based on continuous audio representations (e.g., continuous audio representations generated during the second stage of task-specific fine-tuning 104). The quantized audio representations may retain the acoustic nuances and subtleties of the original audio signal. Then, the user may input the audio tokens 410 into the downstream machine learning model. The downstream machine learning model may utilize the audio tokens 410 to perform a certain task, such as one or more of a text-to-speech task, a lyrics-to-song task, a prompt-to-audio task, and various Music Information Retrieval (MIR) tasks.

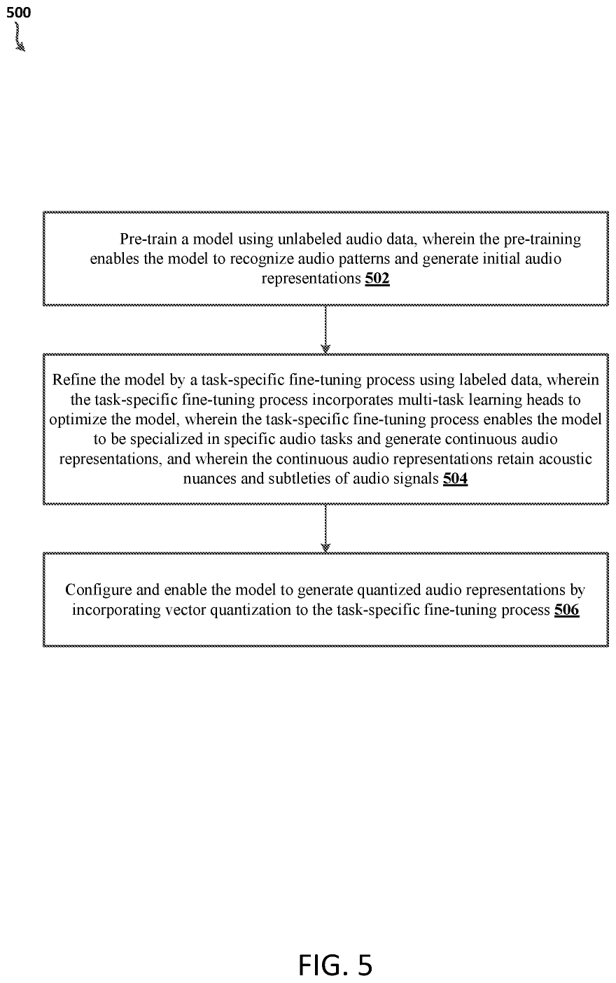

FIG. 5 illustrates an example process 500 for generating audio representations. Although depicted as a sequence of operations in FIG. 5, those of ordinary skill in the art will appreciate that various embodiments may add, remove, reorder, or modify the depicted operations.

At 502, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 504, the machine learning model may be refined by a task-specific fine-tuning process. The machine learning model may be refined using labeled data. The task-specific fine-tuning process may incorporate multi-task learning heads to optimize the machine learning model. The multi-task learning heads may be designed to optimize the machine learning model's capabilities for distinct audio-related tasks, e.g., audio feature reconstruction, harmonic feature reconstruction, and Automatic Speech Recognition (ASR). The task-specific fine-tuning process may enable the machine learning model to be specialized in specific audio tasks and generate continuous audio representations. The continuous audio representations may retain acoustic nuances and subtleties of audio signals.

Once the task-specific fine tuning is complete, a vector quantizer may be used to further enhance the machine learning model. At 506, the machine learning model may be configured and enabled to generate quantized audio representations. The machine learning model may be configured and enabled to generate quantized audio representations by incorporating vector quantization to the task-specific fine-tuning process. The generation of quantized audio representations by the trained model may enable a large language model to model semantic tokens effectively. This is particularly valuable for prediction tasks, where the trained model may be used to generate representations of audio content in a compressed, tokenized form that can be processed by the large language model.

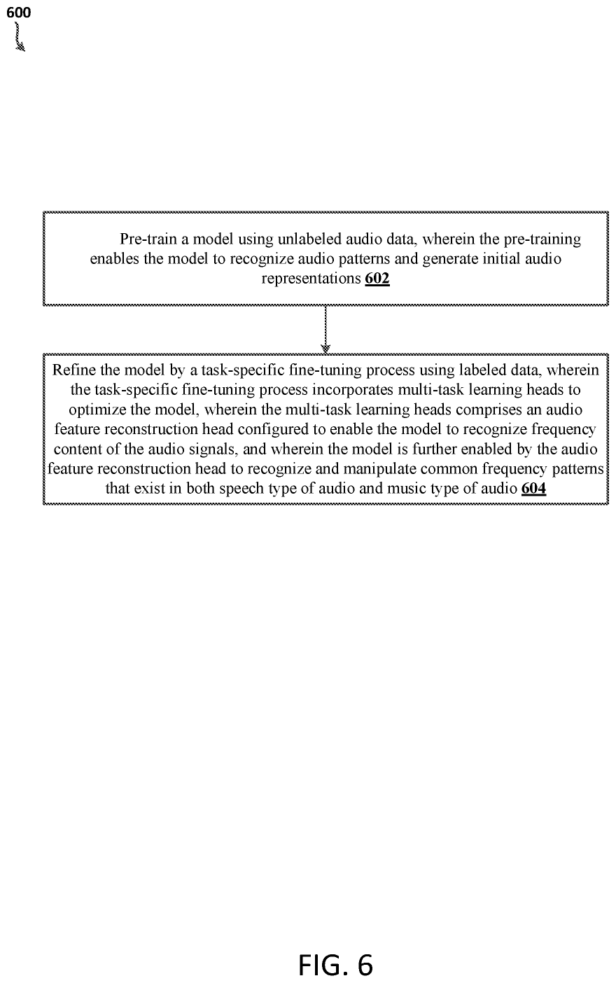

FIG. 6 illustrates an example process 600 for generating audio representations. Although depicted as a sequence of operations in FIG. 6, those of ordinary skill in the art will appreciate that various embodiments may add, remove, reorder, or modify the depicted operations.

At 602, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 604, the machine learning model may be refined by a task-specific fine-tuning process. The machine learning model may be refined using labeled data. The task-specific fine-tuning process may incorporate multi-task learning heads to optimize the machine learning model. The multi-task learning heads may comprise an audio feature reconstruction head (e.g., audio feature reconstruction head 208a). The audio feature reconstruction head may be configured to enable the machine learning model to recognize frequency content of audio signals. The machine learning model is further enabled by the audio feature reconstruction head to recognize and manipulate common frequency patterns that exist in both speech type of audio and music type of audio.

The audio feature reconstruction head may be configured to reconstruct one or more audio features associated with audio. The audio feature(s) may provide a rich source of information about the distribution of sound frequencies over time. By specializing in audio feature reconstruction, the machine learning model becomes adept at understanding the frequency content of audio, which is essential for both speech and music.

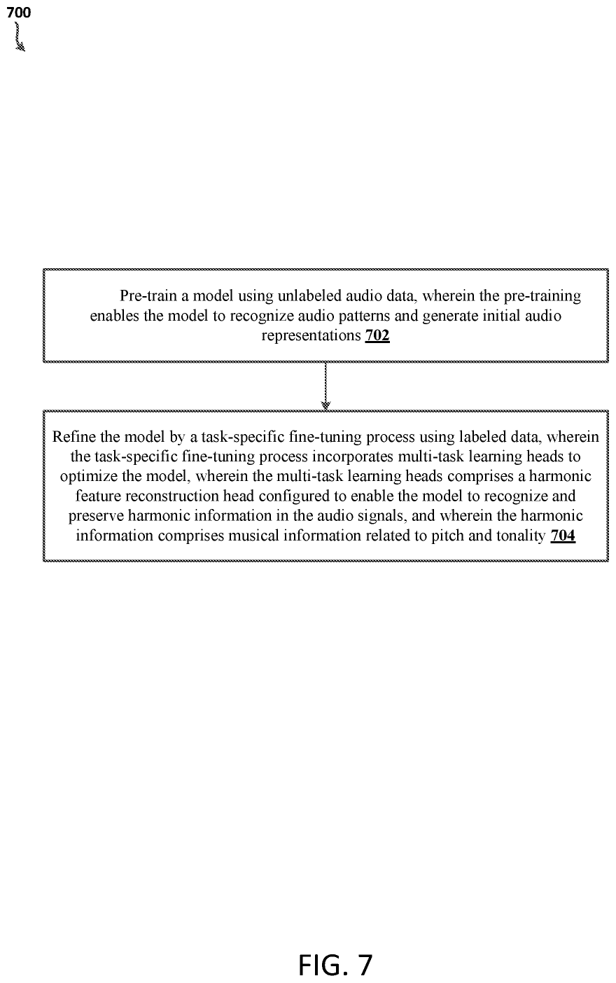

FIG. 7 illustrates an example process 700 for generating audio representations. Although depicted as a sequence of operations in FIG. 7, those of ordinary skill in the art will appreciate that various embodiments may add, remove, reorder, or modify the depicted operations.

At 702, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 704, the machine learning model may be refined by a task-specific fine-tuning process. The machine learning model may be refined using labeled data. The task-specific fine-tuning process may incorporate multi-task learning heads to optimize the machine learning model. The multi-task learning heads may comprise a harmonic feature reconstruction head (e.g., the harmonic feature reconstruction head 208b). The harmonic feature reconstruction head may be configured to enable the machine learning model to recognize and preserve harmonic information in the audio signals. The harmonic information may comprise musical information related to pitch and tonality. The harmonic feature reconstruction head may be configured to reconstruct one or more harmonic features associated with audio. For example, the harmonic feature reconstruction head may be configured to perform harmonic feature reconstruction by attempting to recreate (e.g., predicting) the harmonic features of the audio based on audio representations. By focusing on harmonic aspects, the machine learning model enhances the musicality of the generated content, making it more enjoyable and melodically pleasing.

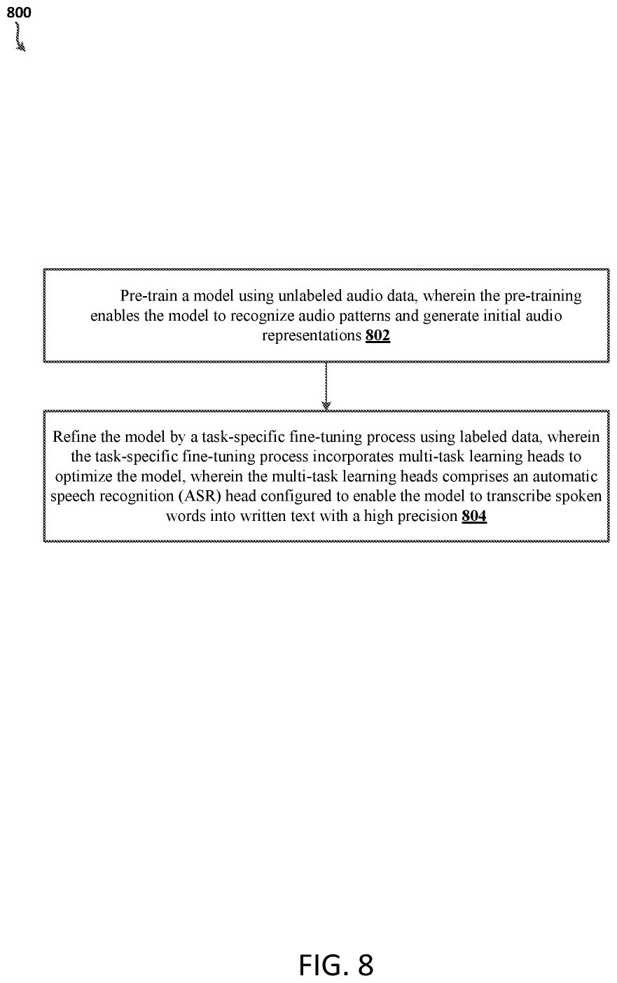

FIG. 8 illustrates an example process 800 for generating audio representations. Although depicted as a sequence of operations in FIG. 8, those of ordinary skill in the art will appreciate that various embodiments may add, remove, reorder, or modify the depicted operations.

At 802, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 804, the machine learning model may be refined by a task-specific fine-tuning process. The machine learning model may be refined using labeled data. The task-specific fine-tuning process may incorporate multi-task learning heads to optimize the machine learning model. The multi-task learning heads may comprise an ASR head (e.g., the ASR head 208c). The ASR head may be configured to enable the machine learning model to transcribe spoken words into written text with a high precision. For example, the ASR head may be configured to transcribe audio to spoken text based on audio representations. The ASR head may enable the machine learning model to convert spoken words into written text with a high precision. The ASR head may be dedicated to improving the machine learning model's performance in understanding and transcribing spoken language. The ASR head may fine-tune the machine learning model's parameters to excel in ASR tasks, ensuring that the machine learning model can convert spoken words into written text with high precision. The ASR head may inherently force the machine learning model to capture and represent features related to pronunciation.

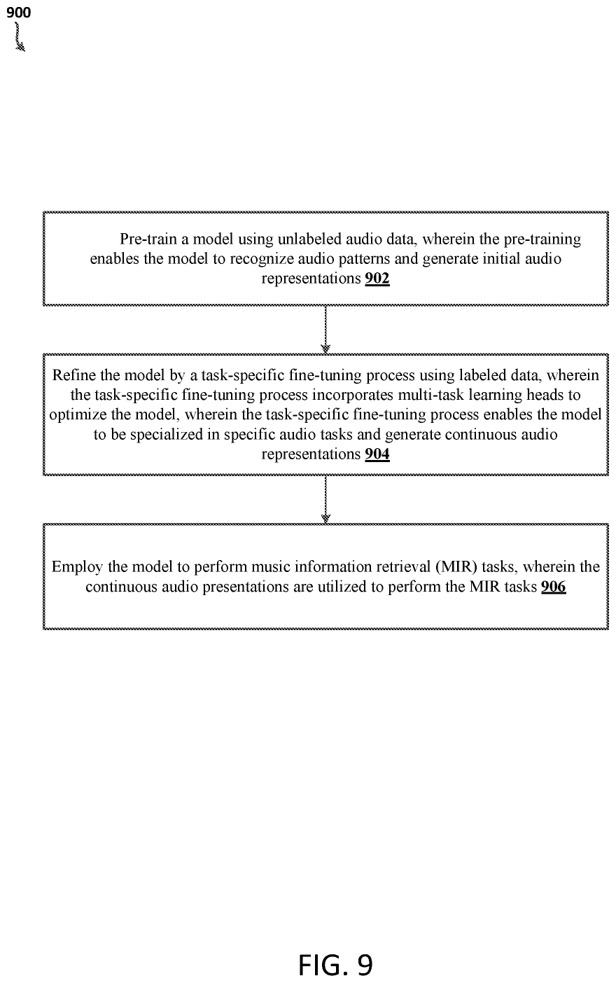

FIG. 9 illustrates an example process 900 for generating audio representations. Although depicted as a sequence of operations in FIG. 9, those of ordinary skill in the art will appreciate that various embodiments may add, remove, reorder, or modify the depicted operations.

At 902, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 904, the machine learning model may be refined. The machine learning model may be refined by a task-specific fine-tuning process. The machine learning model may be refined using labeled data. The task-specific fine-tuning process may incorporate multi-task learning heads to optimize the machine learning model. The multi-task learning heads may be designed to optimize the machine learning model's capabilities for distinct audio-related tasks: audio feature reconstruction, harmonic feature reconstruction, and ASR. The task-specific fine-tuning process may enable the machine learning model to be specialized in specific audio tasks and generate continuous audio representations.

A user may want to utilize a downstream machine learning model that performs a task using continuous audio representations. The user may first utilize the machine learning model that has been trained using the task-specific fine-tuning process to generate continuous audio representations. To utilize the machine learning model to generate continuous audio representations, the user may input audio into the machine learning model that has been trained using the task-specific fine-tuning process to generate continuous audio representations. The trained model may be configured to generate the continuous audio representations associated with the audio. The continuous audio representations may retain the acoustic nuances and subtleties of the original audio signal.

At 906, the machine learning model may be employed to perform music information retrieval (MIR) tasks. The continuous audio representations may be utilized to perform the MIR tasks. For example, the user may input the continuous audio representations into the downstream machine learning model. The downstream machine learning model may utilize the continuous audio representations to perform various MIR tasks.

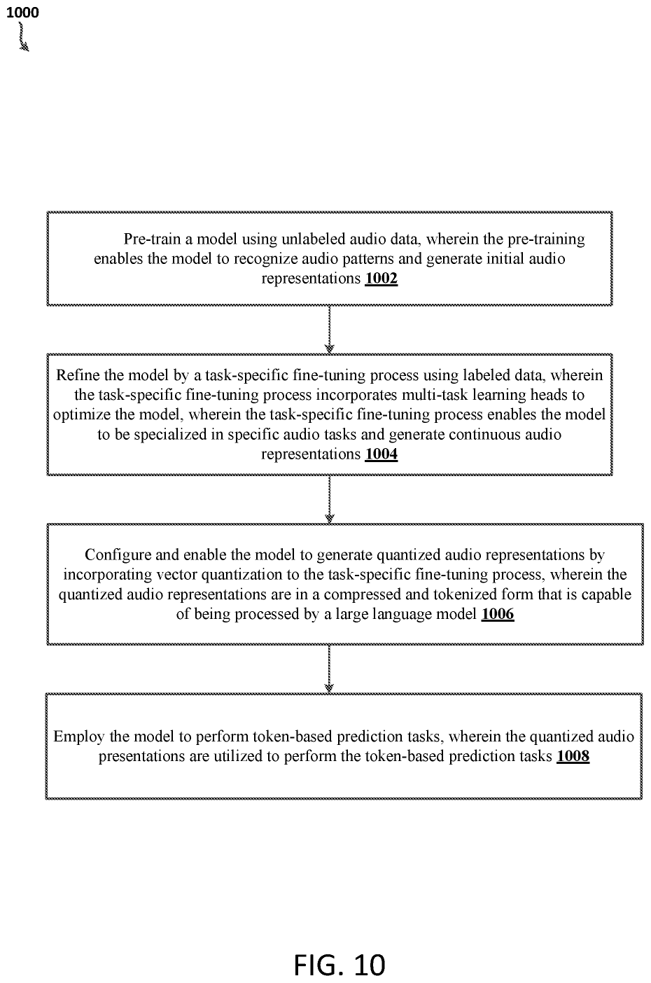

FIG. 10 illustrates an example process 1000 for generating audio representations. Although depicted as a sequence of operations in FIG. 10, those of ordinary skill in the art will appreciate that various embodiments may add, remove, reorder, or modify the depicted operations.

At 1002, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 1004, the machine learning model may be refined. The machine learning model may be refined by a task-specific fine-tuning process. The machine learning model may be refined using labeled data. The task-specific fine-tuning process may incorporate multi-task learning heads to optimize the machine learning model. The multi-task learning heads may be designed to optimize the machine learning model's capabilities for distinct audio-related tasks: audio feature reconstruction, harmonic feature reconstruction, and ASR. The task-specific fine-tuning process may enable the machine learning model to be specialized in specific audio tasks and generate continuous audio representations.

At 1006, the machine learning model may be configured and enabled to generate quantized audio representations. The machine learning model may be configured and enabled to generate quantized audio representations by incorporating vector quantization to the task-specific fine-tuning process. The quantized audio representations may be in a compressed and tokenized form that is capable of being processed by a large language model. For example, the machine learning model may comprise an encoder. The encoder may comprise a stack of layers. A vector quantizer may be inserted in the stack of layers. The encoder with vector quantizer may be configured to generate the quantized audio representations associated with audio. The quantized audio representations may retain the acoustic nuances and subtleties of the original audio signal.

A user may want to utilize a downstream machine learning model that performs a task using quantized audio representations. The user may first utilize the machine learning model that has been trained using the task-specific fine-tuning process with vector quantization to generate quantized audio representations. To utilize the machine learning model to generate quantized audio representations, the user may input audio into the trained model. The trained model may be configured to generate the quantized audio representations (e.g., audio tokens) associated with the audio. The trained model may be configured to generate the quantized audio representations (e.g., audio tokens) associated with the audio based on continuous audio representations (e.g., continuous audio representations generated during the second stage of task-specific fine-tuning). The quantized audio representations may retain the acoustic nuances and subtleties of the original audio signal.

At 1008, the machine learning model may be employed to perform token-based prediction tasks, wherein the quantized audio representations are utilized to perform the token-based prediction tasks. For example, the user may input the quantized audio representations into the downstream machine learning model. The downstream machine learning model may utilize the quantized audio representations to perform various token-based prediction tasks.

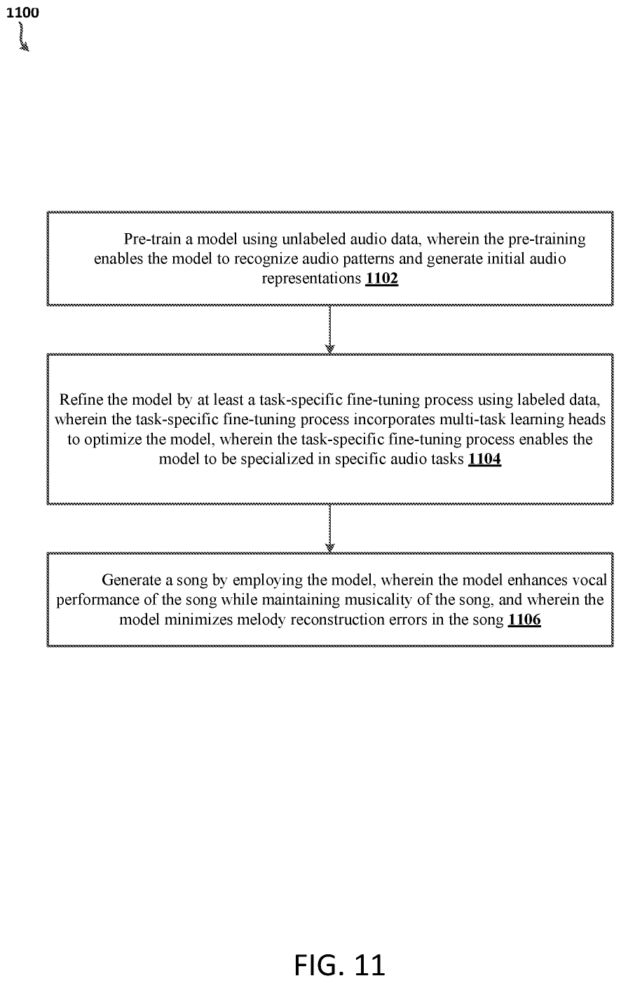

FIG. 11 illustrates an example process 1100 for generating audio representations. Although depicted as a sequence of operations in FIG. 11, those of ordinary skill in the art will appreciate that various embodiments may add, remove, reorder, or modify the depicted operations.

At 1102, a machine learning model may be pre-trained. The machine learning model may be pre-trained using unlabeled audio data. The pre-training may enable the machine learning model to recognize audio patterns and generate initial audio representations. The pre-training may serve as the foundation for initializing the machine learning model's understanding of audio data. The pre-training may equip the machine learning model with a strong initial grasp of audio representations, allowing it to capture essential audio features, patterns, and structures. The pre-training may comprise training the machine learning model on a vast corpus of unlabeled audio data, enabling it to develop a broad and general understanding of audio information. The pre-training may focus on unsupervised learning, where the machine learning model learns to recognize meaningful audio patterns without task-specific labels.

At 1104, the machine learning model may be refined. The machine learning model may be refined by a task-specific fine-tuning process. The machine learning model may be refined using labeled data. The task-specific fine-tuning process may incorporate multi-task learning heads to optimize the machine learning model. The multi-task learning heads may be designed to optimize the machine learning model's capabilities for distinct audio-related tasks: audio feature reconstruction, harmonic feature reconstruction, and ASR. The task-specific fine-tuning process may enable the machine learning model to be specialized in specific audio tasks.

At 1106, the machine learning model may be employed to generate a song. The machine learning model may enhance vocal performance of the song while maintaining musicality of the song. The machine learning model may minimize melody reconstruction errors in the song. The quantized audio representations and/or the continuous audio representations may be used to generate the song. For example, the user may input the quantized audio representations and/or the continuous audio representations into a downstream machine learning model. The downstream machine learning model may utilize the quantized audio representations to generate a song.

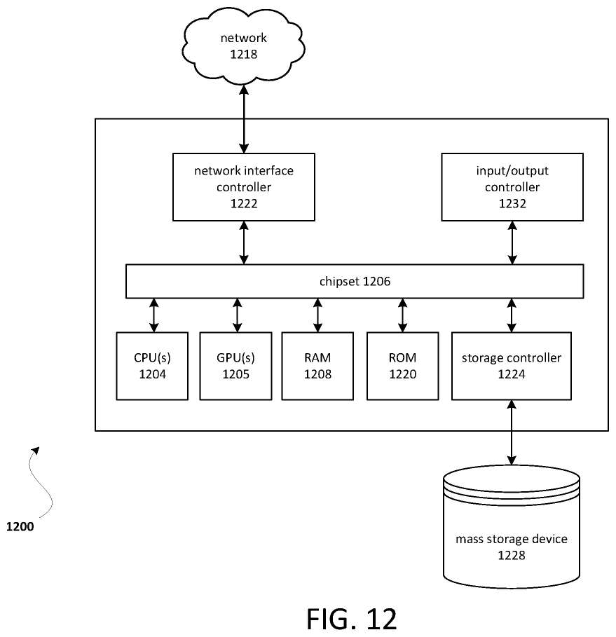

FIG. 12 illustrates a computing device that may be used in various aspects, such as the services, networks, modules, and/or devices depicted in any of FIGS. 1-4. With regard to FIGS. 1-4, any or all of the components may each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN). The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. The mass storage device 1228 may comprise a management component 1210. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on the mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of generating audio representations using a machine learning model, comprising:
pre-training the machine learning model using unlabeled audio data, wherein the pre-training enables the machine learning model to recognize audio patterns and generate initial audio representations;
refining the machine learning model by a task-specific fine-tuning process using labeled data, wherein the task-specific fine-tuning process incorporates multi-task learning heads to optimize the machine learning model, wherein the task-specific fine-tuning process enables the machine learning model to be specialized in specific audio tasks and generate continuous audio representations, and wherein the continuous audio representations retain acoustic nuances and subtleties of audio signals; and
configuring and enabling the machine learning model to generate quantized audio representations by incorporating vector quantization to the task-specific fine-tuning process.

2. The method of claim 1, wherein the multi-task learning heads comprises:
an audio feature reconstruction head configured to enable the machine learning model to recognize frequency content of the audio signals;
a harmonic feature reconstruction head configured to enable the machine learning model to recognize and preserve harmonic information in the audio signals; and
an automatic speech recognition (ASR) head configured to enable the machine learning model to transcribe spoken words.

3. The method of claim 2, further comprising:
enabling the machine learning model by the audio feature reconstruction head to recognize and manipulate common frequency patterns that exist in both speech type of audio and music type of audio.

4. The method of claim 2, wherein the harmonic information comprises musical information related to pitch and tonality.

5. The method of claim 2, further comprising:
enabling the machine learning model by the ASR head to convert spoken words into written text with a high precision.

6. The method of claim 1, wherein the quantized audio representations are in a compressed and tokenized form that is capable of being processed by a large language machine learning model.

7. The method of claim 1, further comprising:
generating a song by employing the machine learning model, wherein the machine learning model enhances vocal performance of the song while maintaining musicality of the song, and wherein the machine learning model minimizes melody reconstruction errors in the song.

8. The method of claim 1, further comprising:
employing the machine learning model to perform music information retrieval (MIR) tasks, wherein the continuous audio representations are utilized to perform the MIR tasks.

9. The method of claim 1, further comprising:
employing the machine learning model to perform token-based prediction tasks, wherein the quantized audio representations are utilized to perform the token-based prediction tasks.

10. A system of generating audio representations using a machine learning model, comprising:
at least one processor; and
at least one memory communicatively coupled to the at least one processor and comprising computer-readable instructions that upon execution by the at least one processor cause the at least one processor to perform operations comprising:
pre-training the machine learning model using unlabeled audio data, wherein the pre-training enables the machine learning model to recognize audio patterns and generate initial audio representations;
refining the machine learning model by a task-specific fine-tuning process using labeled data, wherein the task-specific fine-tuning process incorporates multi-task learning heads to optimize the machine learning model, wherein the task-specific fine-tuning process enables the machine learning model to be specialized in specific audio tasks and generate continuous audio representations, and wherein the continuous audio representations retain acoustic nuances and subtleties of audio signals; and
configuring and enabling the machine learning model to generate quantized audio representations by incorporating vector quantization to the task-specific fine-tuning process.

11. The system of claim 10, wherein the multi-task learning heads comprises:
an audio feature reconstruction head configured to enable the machine learning model to recognize frequency content of the audio signals;
a harmonic feature reconstruction head configured to enable the machine learning model to recognize and preserve harmonic information in the audio signals; and
an automatic speech recognition (ASR) head configured to enable the machine learning model to transcribe spoken words.

12. The system of claim 11, the operations further comprising:
enabling the machine learning model by the audio feature reconstruction head to recognize and manipulate common frequency patterns that exist in both speech type of audio and music type of audio.

13. The system of claim 11, wherein the harmonic information comprises musical information related to pitch and tonality.

14. The system of claim 11, the operations further comprising:
enabling the machine learning model by the ASR head to convert spoken words into written text with a high precision.

15. The system of claim 10, wherein the quantized audio representations are in a compressed and tokenized form that is capable of being processed by a large language machine learning model.

16. A non-transitory computer-readable storage medium, storing computer-readable instructions that upon execution by a processor cause the processor to implement operations comprising:
pre-training a machine learning model using unlabeled audio data, wherein the pre-training enables the machine learning model to recognize audio patterns and generate initial audio representations;
refining the machine learning model by a task-specific fine-tuning process using labeled data, wherein the task-specific fine-tuning process incorporates multi-task learning heads to optimize the machine learning model, wherein the task-specific fine-tuning process enables the machine learning model to be specialized in specific audio tasks and generate continuous audio representations, and wherein the continuous audio representations retain acoustic nuances and subtleties of audio signals; and
configuring and enabling the machine learning model to generate quantized audio representations by incorporating vector quantization to the task-specific fine-tuning process.

17. The non-transitory computer-readable storage medium of claim 16, wherein the multi-task learning heads comprises:
an audio feature reconstruction head configured to enable the machine learning model to recognize frequency content of the audio signals;
a harmonic feature reconstruction head configured to enable the machine learning model to recognize and preserve harmonic information in the audio signals; and
an automatic speech recognition (ASR) head configured to enable the machine learning model to transcribe spoken words.

18. The non-transitory computer-readable storage medium of claim 17, the operations further comprising:
enabling the machine learning model by the audio feature reconstruction head to recognize and manipulate common frequency patterns that exist in both speech type of audio and music type of audio.

19. The non-transitory computer-readable storage medium of claim 17, wherein the harmonic information comprises musical information related to pitch and tonality.

20. The non-transitory computer-readable storage medium of claim 17, the operations further comprising:
enabling the machine learning model by the ASR head to convert spoken words into written text with a high precision.
